(19) United States
(12) Patent Application Publication
(10) Pub. No.: US 2017/0095105 A1
(43) Pub. Date: Apr. 6, 2017

(54) MINI STEAM GENERATOR FOR COOKING FOOD, MODULAR COOKING APPLIANCE, AND MODULAR FOOD PREPARATION STATION

(71) Applicants: JOSEPH R. CLARK, NAPERVILLE, IL (US); JAMES R. BUCHLER, ORLAND PARK, IL (US)

(72) Inventors: JOSEPH R. CLARK, NAPERVILLE, IL (US); JAMES R. BUCHLER, ORLAND PARK, IL (US)

(21) Appl. No.: 15/248,313

(22) Filed: Aug. 26, 2016

Related U.S. Application Data
(60) Provisional application No. 62/237,114, filed on Oct. 5, 2015.

(51) Int. Cl. A47J 27/00; A47J 27/04

(52) U.S. Cl. CPC A47J 27/002; A47J 27/04; A47J 2027/043

(57) ABSTRACT

A mini steam generator for preparing or cooking various different types of food through means of a steaming process is disclosed. The mini steam generator is compact in size and is fluidically coupled to one or more cooking chambers for preparing or cooking the desired food products. The mini steam generator and the one or more cooking chambers may be disposed within a modular cooking appliance housing, and two or more modular cooking appliance housings may be fixedly connected together so as to effectively form a food preparation assembly or food preparation station.

### CROSS-REFERENCE TO RELATED PATENT APPLICATION

This patent application is a non-provisional patent application conversion of U.S. Provisional Patent Application Ser. No. 62/237,114 that was filed on Oct. 5, 2015, the priority benefits of which are hereby claimed.

### FIELD OF THE INVENTION

The present invention relates generally to food preparation apparatus, equipment, or appliances, and more particularly to a mini steam generator for preparing or cooking various different types of food through means of a steaming process. The mini steam generator is compact in size and is fluidically coupled to one or more cooking chambers for preparing or cooking the desired food products. The mini steam generator and the one or more cooking chambers may be disposed within a modular cooking appliance housing, and two or more modular cooking appliance housings may be fixedly connected together so as to effectively form a food preparation assembly or food preparation station.

### BACKGROUND OF THE INVENTION

Steam cooking is an extremely efficient cooking method for cooking food, however, steamers that are conventionally used for cooking food are usually very large, are used to prepare large volumes of food, and sometimes employ flash steamers which do not utilize a boiler. Flash steamers are plagued with inefficiencies with respect to steam loss and calcification problems, and are conventionally used to cook or rethermalize food. However, in the fast-food industry, for example, the industry effectively demands faster cooking times so as to be capable of handling fast-food orders in a relatively short period of time. In addition, spatial considerations within a particular fast-food establishment usually mandate limited kitchen facility areas which, in turn, usually mandate the use of relatively small or compact food cooking appliances such as, for example, those that can be placed or installed upon tabletops or countertops.

A need therefore exists in the art for a new and improved mini steam generator for cooking food wherein the aforenoted disadvantages or operational drawbacks characteristic of conventional cooking apparatus, equipment, or appliances are effectively overcome or eliminated. More particularly, a need exists in the art for a new and improved mini steam generator wherein the mini steam generator is relatively small in size. Still more particularly, a need exists in the art for a new and improved mini steam generator wherein the mini steam generator can effectively be fluidically connected with one or more food cooking chambers. Still further, a need exists in the art for a new and improved mini steam generator wherein the mini steam generator, and the one or more food cooking chambers fluidically connected to the mini steam generator, can be incorporated within a modular cooking appliance housing. Yet further, a need exists in the art for a new and improved mini steam generator wherein the mini steam generator, and the one or more food cooking chambers fluidically connected to the mini steam generator and incorporated within the modular cooking appliance housing, can be fixedly connected to other modular cooking appliance housings so as to effectively form a food preparation assembly or food preparation station which can in fact be utilized to prepare fast food at a relatively rapid pace and within relatively short periods of time so as to be capable of providing fast-food products in accordance with the fast-pace demand for such fast-food products which is conventionally characteristic of fast-food establishments.

### OVERALL OBJECTIVES OF THE INVENTION

The overall objectives of the present invention are to provide a new and improved mini steam generator for cooking food which will overcome and eliminate the various disadvantages and drawbacks characteristic of conventional steam generators for cooking food, to provide a new and mini steam generator for cooking food which will be relative small in size, to provide a new and improved mini steam generator wherein the mini steam generator can effectively be fluidically connected to one or more food cooking chambers, to provide a new and improved mini steam generator wherein the mini steam generator, and the one or more food cooking chambers fluidically connected thereto, can be incorporated within a modular cooking appliance housing, to provide a new and improved mini steam generator wherein the mini steam generator, and the one or more food cooking chambers fluidically connected thereto and incorporated within the modular cooking appliance housing, can be fixedly connected to other modular cooking appliance housings so as to effectively form a food preparation assembly or food preparation station which can in fact be utilized to prepare fast food at a relatively rapid pace and within relatively short periods of time so as to be capable of providing fast-food products in accordance with the fast-pace demand for such fast-food products that is conventionally characteristic of fast-food establishments.

### SUMMARY OF THE INVENTION

The foregoing and other objectives are achieved in accordance with the teachings and principles of the present invention through the provision of a new and improved mini steam generator wherein, in accordance with a first embodiment of the mini steam generator, a plurality of immersion heaters, the number of which may vary dependent upon the steam requirements, are disposed internally within a cylindrical housing or tube fabricated from stainless steel. The outside diameter of the cylindrical housing or tube can vary from approximately two to six inches (2.00-6.00″) and has an axial length of which can vary between approximately ten and twenty inches (10.00-20.00″). The immersion heaters extend axially into the cylindrical housing or tube and are disposed within the lower half of the housing or tube. An inlet water supply tube, having a water inlet pump and a baffle member operatively associated therewith, is provided so as to supply water into the interior portion of the cylindrical housing or tube. A radially extending probe projects through a side wall portion of the cylindrical housing or tube so as to effectively detect the level of water within the cylindrical housing or tube. When the water level reaches the probe, the probe senses the same and serves to terminate operation of the water inlet pump. A pair of steam outlet valves are fluidically connected to the interior portion of the cylindrical housing or tube and are initially disposed at their open positions. When the immersion heaters are energized so as to begin to cause the water to be heated, and when the water reaches a temperature of, for example, between 207° F. and 209° F., the steam outlet valves are moved to their closed positions, the pressure within the cylindrical housing or tube is elevated to a pressure level of approximately 27 PSI, and the temperature of the steam is approximately 275° F. The steam is then routed to the food cooking chambers whereby the food is steamed and cooked. It is to be noted that the mini steam generator can operatively serve one or more cooking chambers, which have, for example, a pair of drawers mounted therewithin which are slidably movable in directions perpendicular to the orientation of the mini steam generator, and together, the mini steam generator and the one or more food cooking chambers, serve to define a modular cooking appliance housing. In addition, two or more modular cooking appliance housings can be fixedly connected together, either in a side-by-side or vertically stacked arrangement, so as to define a food cooking assembly or a food preparation station. In accordance with a second embodiment of the present invention, which is effectively a variation of the first embodiment of the present invention, a single spatula or food product holder is likewise slidable into and out from the food cooking chamber in a direction which is substantially parallel to the longitudinal axis of the mini steam generator wherein the spatula and food cooking chamber are effectively disposed in a side-by-side arrangement with respect to the mini steam generator.

In accordance with a third embodiment, an inner cylindrical housing or tube is disposed within an outer cylindrical housing or tube such that an annular space is defined between the external peripheral wall portion of the inner cylindrical housing or tube and the internal peripheral wall portion of the outer cylindrical housing or tube. The external peripheral wall portion of the inner cylindrical housing or tube is provided with a plurality of axially spaced, radially extending heat exchanger fins which extend along substantially the entire axial extent of the inner cylindrical housing or tube. A plurality of non-immersion heaters are disposed within the inner cylindrical housing or tube and are arranged within a circumferential array around the longitudinal axis of the inner cylindrical housing or tube. The non-immersion heaters are infrared heaters which can attain a temperature level of approximately 1900° F. A water supply conduit is fixedly secured in a coiled array upon the external peripheral surface portion of the outer cylindrical housing or tube, and the water outlet end of the water supply conduit is fluidically connected to the annular space defined between the external peripheral wall portion of the inner cylindrical housing or tube and the internal peripheral wall portion of the outer cylindrical housing or tube. In this manner, when the infrared non-immersion heaters are energized, they serve to heat the cylindrical wall portion forming the inner cylindrical housing or tube which thereby, in turn, causes the plurality of radially extending heat exchanger fins to be heated so as to heat the water, disposed within the annular chamber defined between the external peripheral wall portion of the inner cylindrical housing or tube and the internal peripheral wall portion of the outer cylindrical housing or tube, thereby causing the water to effectively be converted to steam which is fluidically conducted toward and into the food cooking chambers. The entire mini steam generator of this embodiment, including the external housing or tube, the inner housing or tube, the plurality of heat exchanger fins, and the coiled water supply conduit, is fabricated from copper. The external housing has a diametrical extent of between approximately two to six inches (2.00-6.00″) and an axial length of between approximately ten and twenty inches (10.00-14.00″).

It is to be noted that the heated water and steam, disposed within the annular chamber defined between the external peripheral wall portion of the inner cylindrical housing or tube and the internal peripheral wall portion of the outer cylindrical housing or tube, also serves to heat the cylindrical wall portion forming the outer cylindrical housing or tube and thereby also effectively heat the coiled water supply conduit fixedly secured to the outer peripheral surface of the cylindrical wall portion forming the outer cylindrical housing or tube. In this manner, the water disposed within, and flowing through, the coiled water supply conduit is efficiently preheated from its inflowing water temperature of, for example, 50° F., and prior to its entry into the annular chamber defined between the external peripheral wall portion of the inner cylindrical housing or tube and the internal peripheral wall portion of the outer cylindrical housing or tube, whereby the incoming water will then be heated, within the annular chamber defined between the external peripheral wall portion of the inner cylindrical housing or tube and the internal peripheral wall portion of the outer cylindrical housing or tube, so as to ultimately be heated to 212° F. and thereby be converted into steam for fluidic communication to the food cooking chambers.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a perspective view of a first embodiment of a new and improved mini steam generator, constructed in accordance with the principles and teachings of the present invention, and showing the cooperative parts thereof;

FIG. 2 is a front perspective view of a modular food preparation or cooking housing having the mini steam generator incorporated within a rear portion thereof and operatively connected to a pair of food drawers or cooking chambers which are slidably disposed within a front portion of the modular food preparation or cooking housing so as to house food which is adapted to be cooked by means of the steam generated by means of the mini steam generator;

FIG. 3 is a rear perspective view of the modular food preparation or cooking housing as illustrated within FIG. 2 clearly showing the mini steam generator disposed within the rear portion of the modular food preparation or cooking housing;

FIG. 4 is a front perspective view similar to that of FIG. 2 showing, however, a pair of modular food preparation or cooking housings, as illustrated within FIG. 2, vertically stacked with one atop another, so as to form a modular food preparation or cooking assembly or station;

FIG. 5 is a perspective view, similar to that of FIG. 2, showing however a second embodiment variation of the first embodiment of the present invention modular cooking appliance wherein the mini steam generator and the food cooking chamber are effectively disposed within a modular cooking appliance within which the mini steam generator and the food cooking chamber are disposed in a side-by-side arrangement;

FIG. 6 is a perspective view, similar to that of FIG. 4, showing however a pair of modular cooking appliances, as illustrated within FIG. 5, disposed in a side-by-side arrangement so as to form a food preparation station;

FIG. 7 is a perspective view similar to that of FIG. 5 showing however a first pair of modular cooking appliances, as illustrated within FIGS. 5 and 6, disposed atop a second pair of modular cooking appliances, as illustrated within FIGS. 5 and 6, so as to effectively form an expanded food preparation station;

FIG. 8 is a perspective view, similar to that of FIG. 1, showing however a third embodiment of a new and improved mini steam generator, constructed in accordance with the principles and teachings of the present invention, and showing the cooperative parts thereof; and

FIG. 9 is a cross-sectional view of the mini steam generator as illustrated in FIG. 8 and as taken along lines 9-9 of FIG. 8.

### DETAILED DESCRIPTION OF THE PREFERRED EMBODIMENT

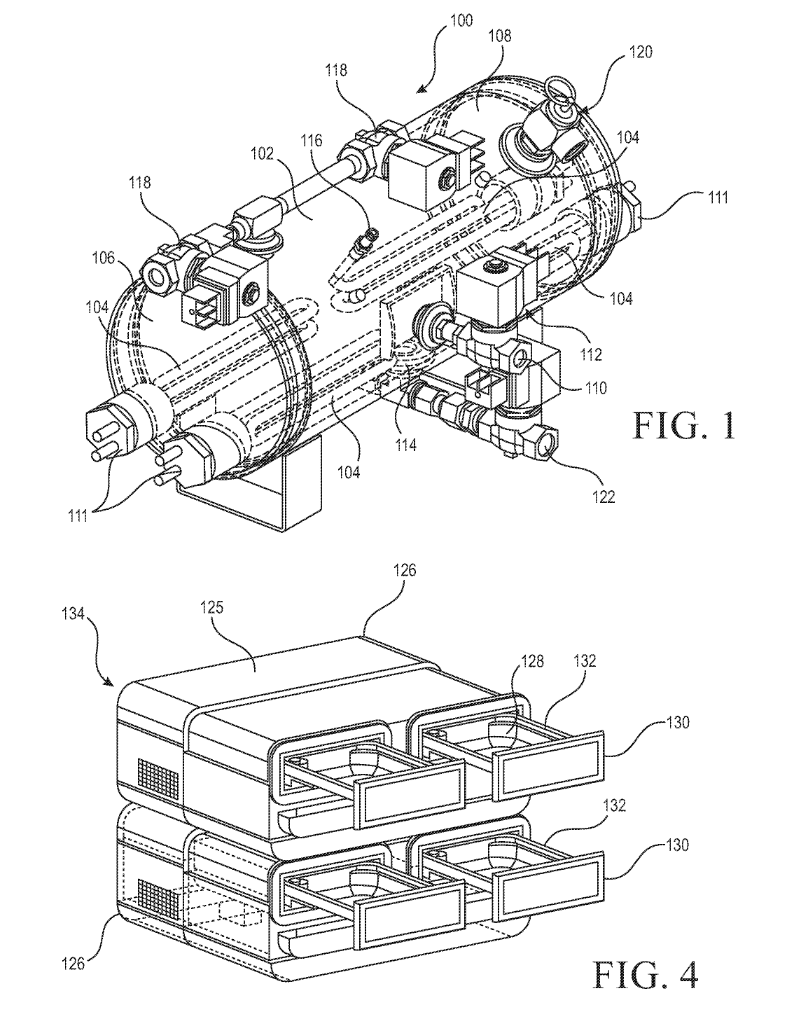

Referring now to the drawings, and more particularly to FIG. 1 thereof, a first embodiment of a new and improved mini steam generator, constructed in accordance with the principles and teachings of the present invention and illustrating the cooperative parts thereof, is disclosed and is generally indicated by the reference character 100 for use with an appliance for preparing food by a steam cooking process. More particularly, it is seen that the first embodiment of the mini steam generator 100, constructed in accordance with the principles and teachings of the present invention, is seen to comprise a cylindrical housing or tube 102 that is fabricated from stainless steel and within which a plurality of immersion heaters 104 are disposed. It is to be noted that in the illustrated mini steam generator 100, four (4) immersion heaters 104 are disclosed, however, the number of immersion heaters 104 may vary dependent upon the steam requirements. More particularly, it is noted that the four immersion heaters 104 are disposed in oppositely disposed pairs with two of the immersion heaters 104 being inserted through a left end wall 106 of the mini steam generator 100, while the other two immersion heaters 104 are inserted through a right end wall 108 of the mini steam generator 100, the electrical connectors 109 of the immersion heaters 104 being disposed externally of the cylindrical housing or tube 102. The outside diameter of the cylindrical housing or tube 102 is approximately six inches (6.00″), and the cylindrical tube or housing 102 has an axial length of approximately sixteen inches (16.00″). The immersion heaters 104 extend axially into the cylindrical housing or tube 102 and are disposed within the lower half portion of the cylindrical housing or tube 102. An inlet water supply tube 110, having a water inlet pump 112 and a baffle member 114 operatively associated therewith, is provided so as to supply water into the interior portion of the cylindrical housing or tube 102. A radially extending probe 116 projects through a side wall portion of the cylindrical housing or tube 102 so as to effectively detect the level of the water within the cylindrical housing or tube 102. Accordingly, when the water level within the cylindrical housing or tube 102 reaches the distal end of the probe 116 which is disposed within the cylindrical housing or tube 102, the probe 116 senses the same and serves to terminate the operation of the water inlet pump 112.

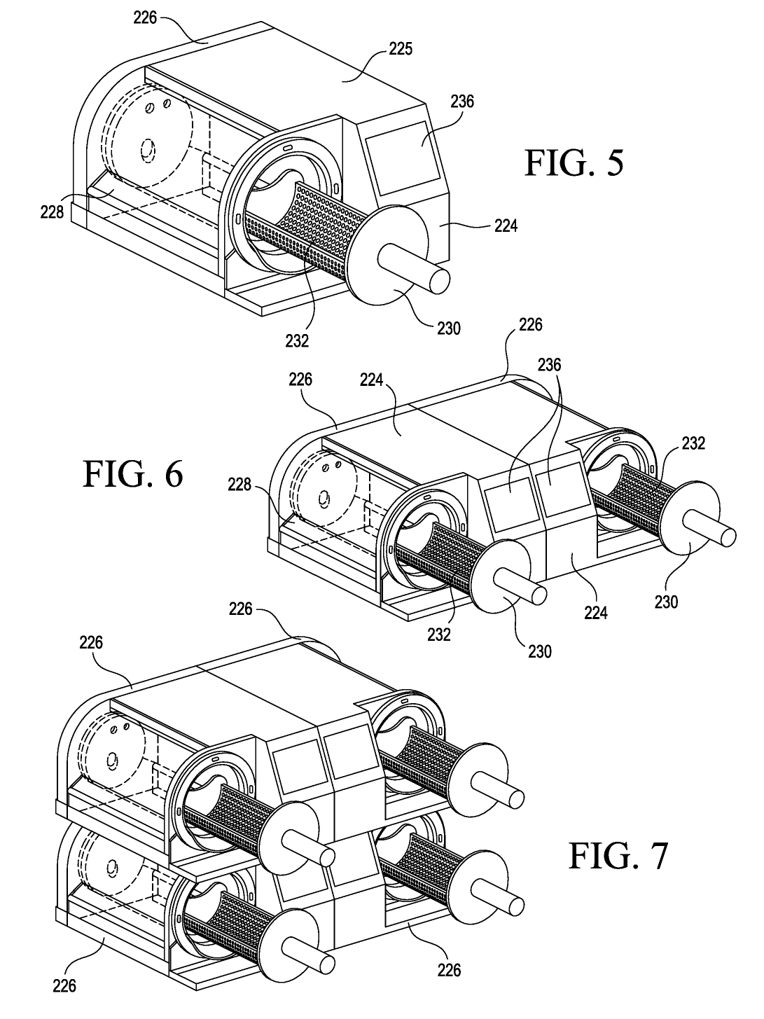

A pair of thermostatically-controlled steam outlet valve assemblies 118 are fixedly secured to external surface portions of the cylindrical housing or tube 102 but are fluidically connected to the interior portion of the cylindrical housing or tube 102 so as to permit steam to flow therethrough when steam is to be conducted to the food preparation appliance. The steam outlet valve assemblies 118 are initially disposed at their open positions such that when the immersion heaters 104 are energized so as to begin to cause the water to be heated, steam and pressure are slowly elevated internally within the cylindrical housing or tube 102 whereby air, disposed within the upper half portion of the cylindrical housing or tube 102, is forced outwardly through the steam outlet valve assemblies 118. When the water reaches a temperature of, for example, between 207° F. and 209° F., the steam outlet valves 118 will be automatically moved to their closed positions, as a result of their thermostatic control, the pressure within the cylindrical housing or tube 102 will be elevated to 27 PSI, and the temperature of the steam will be approximately 275° F. The steam is then routed to food cooking chambers of the cooking appliance whereby the food is steamed and cooked. It is to be noted that the mini steam generator 100 is also provided with a pressure relief valve 120 for relieving excessive pressures within the cylindrical housing or tube 102 so as to maintain the structural integrity and use of the cylindrical housing or tube 102 safe. Still further, the cylindrical housing or tube 102 is also provided with a thermostatically controlled drain valve 122 for permitting drainage of the cylindrical housing or tube 102 when desired, such as, for example, for cleaning, maintenance, and the like. It is to be noted that in accordance with regulations within the food industry, it is not permitted to drain heated water when the temperature of the water is above 140° F. Accordingly, to initiate drainage of the heated water, personnel will initially input a shutdown command upon a user interface, not shown in FIG. 1 but illustrated in FIG. 5 upon a modular cooking appliance similar to one within which the mini steam generator 100 can be employed and as will be discussed more fully hereinafter, so as to terminate the energization of the immersion heaters, followed by the opening of the steam outlet valve assemblies 118. Opening of the steam outlet valve assemblies 118 then permits steam, within the cylindrical housing or tube 102 of the mini steam generator, to escape to atmosphere with a concomitant cooling of the water. When the temperature of the water effectively cools to a temperature level of approximately 130° F., the thermostatically controlled drain valve 122 opens so as to permit the drainage of the cylindrical housing or tube 102 to be commenced, the atmospheric pressure within the cylindrical housing or tube 102 assisting the drainage of the water from the cylindrical housing or tube 102.

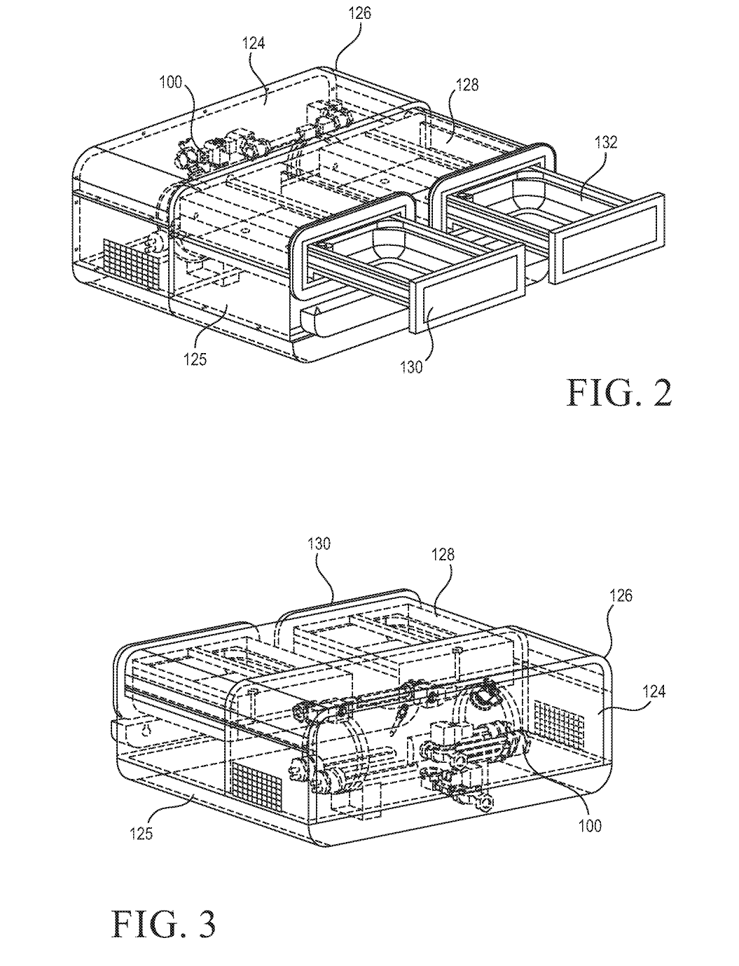

With reference being made to FIGS. 2-4, it is to be noted that the mini steam generator can operatively serve one or more food cooking chambers, and together, the mini steam generator and the one or more food cooking chambers serve to define a modular cooking appliance. In addition, two or more modular cooking appliances can be fixedly connected together, either in a side-by-side or vertically stacked arrangement, so as to define a food preparation or cooking assembly or station. More particularly, as seen in FIGS. 2 and 3, a mini steam generator 100, as has been illustrated in more detail within FIG. 1, is disposed within a rear chamber 124 of a housing 125 of a modular cooking appliance 126, while a pair of food cooking chambers 128,128 are effectively defined within front portions of the modular cooking appliance 126. As can best be seen from FIG. 2, the food cooking chambers 128,128 are effectively structural cabinets within which a pair of drawers 130,130 are movably mounted. Each one of the pair of drawers 130,130 is provided with a food-holding tray 132,132. The pair of drawers 130,130 are slidably disposed within the cooking chambers or cabinets 128,128 for movement between outward or withdrawn positions so as to effectively enable food to be deposited into the food holding trays 132,132, or to permit cooked food products to be removed from the food-holding trays 132,132. When the drawers 130, 130 and the food-holding trays 132,132 are moved inwardly to inserted positions internal within the cooking chambers or cabinets 128,128, steam from the mini steam generator 100, which is routed into the food cooking chambers 128,128 by means of suitable conduits, not shown, serves to cook the food within the food-holding trays 132,132. It is to be noted that the housing portions of the modular cooking appliance 126 are fabricated from stainless steel, however, the food-holding trays 132,132 are fabricated from polysulfone, or a similar material, so as to provide better cooking efficiency and better heat retention properties. Continuing further, as can best be appreciated from FIG. 4, and as has been noted hereinbefore, one or more of the modular cooking appliances 126 can be fixedly connected to one or more other modular cooking appliances 126, either in a side-by-side mode or a vertically stacked mode as illustrated within FIG. 4, so as to effectively form a food cooking assembly or a food preparation station 134.

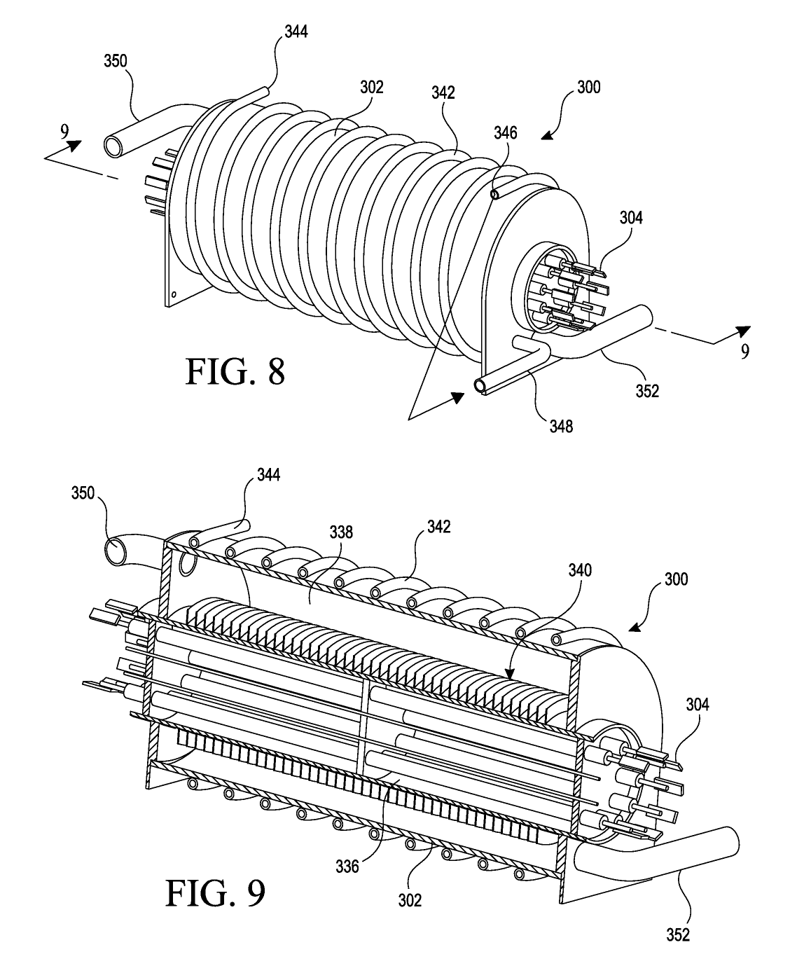

With reference now being made to FIGS. 5-7, a second embodiment of the present invention modular cooking appliance, which is effectively a variation of the first embodiment of the present invention modular cooking appliance as has been illustrated within FIGS. 2-4, is disclosed and is generally indicated by the reference character 200. It is to be noted that component parts of the second embodiment of the present invention, which correspond to component parts of the first embodiment of the present invention, will be designated by corresponding reference numbers except that the reference numbers will be within the 200 series. Accordingly, with reference first being made to FIG. 5, it is seen that the second embodiment modular cooking appliance 226 comprises a stainless steel housing 225, partially cut away so as to illustrate the interior portion of the housing 225, and it is seen that the housing 225 comprises a right side housing portion 224, for accommodating a mini steam generator that may be similar to the mini steam generator as illustrated within FIGS. 8 and 9 and as will be discussed more fully hereinafter, and a left side housing portion 228 that effectively comprises a sealed steam chamber for accommodating a spatula or a similar implement or drawer 230 which has a food-support tray 232 fixedly mounted thereon. The sealed steam chamber 228 is preferably fabricated from polysulfone or a similar material for thermal efficiency and heat loss prevention. The drawer 230 and food-support tray 232 may be slidably moved into and out from the sealed steam chamber 228, as guided by suitable railing or rack structure, not shown, so as to permit food, to be cooked, to be inserted into the sealed steam chamber 228, or to remove cooked food from the food-support tray 232 after the food has been cooked within the sealed steam chamber 228. A user interface or keypad 236 is incorporated upon or within the front face of the right side housing portion 224 so as to control or predetermine, for example, the various cooking parameters for a particular type of food to be cooked within the modular cooking appliance 226. In a manner similar to that illustrated within FIG. 4, wherein, for example, a pair of modular food cooking appliances 126 were disclosed as being capable of being connected together so as to form a food preparation station 134, FIG. 6 illustrates a pair of modular food cooking appliances 226,226 connected together in a side-by-side manner so as to form a food preparation station 234. Still further, as illustrated within FIG. 7, four modular food cooking appliances 226,226,226,226 may connected together in a side-by-side and vertically stacked array so as to effectively form an expanded food preparation station 238.

Lastly, with reference being made to FIGS. 8 and 9, and in accordance with a third embodiment of the present invention, another mini steam generator is disclosed and generally indicated by the reference character 300. It is to be noted that component parts of the third embodiment of the present invention, which correspond to component parts of the first embodiment of the present invention, will be designated by corresponding reference numbers except that the reference numbers will be within the 300 series. It is to be additionally noted that there are several features of the third embodiment mini steam generator 300 which differ from the first embodiment mini steam generator. For example, unlike the mini steam generator 100 as disclosed within FIGS. 1-4, the mini steam generator 300 does not employ immersion type heaters 104 but, to the contrary, non-immersion type heating elements, and the pressure within the third embodiment mini steam generator is atmospheric whereby the water will boil at 212° F. In addition, the third embodiment mini steam generator 300 is fabricated from copper and not stainless steel. Lastly, as has been noted hereinbefore, the third mini steam generator 300 is adapted to be utilized within the second embodiment modular cooking appliances 226. Accordingly, with reference being made to FIGS. 8 and 9, it is seen that the third embodiment mini steam generator 300 comprises an inner cylindrical tube or housing 336 disposed within an outer cylindrical housing or tube 302 such that an annular space 338 is defined between the external peripheral wall portion of the inner cylindrical housing or tube 336 and the internal peripheral wall portion of the outer cylindrical housing or tube 302. The external peripheral wall portion of the inner cylindrical housing or tube 336 is provided with a plurality of axially spaced, radially oriented circumferentially extending heat exchanger fins 340 which extend along substantially the entire axial extent of the inner cylindrical housing or tube 336. A plurality of non-immersion heaters or heating elements 304 are disposed within the inner cylindrical tube or housing 336 and are arranged within a circumferential array around the longitudinal axis of the inner cylindrical housing or tube 336. The non-immersion heaters or heating elements 304 are infrared heaters which can attain a temperature level of approximately 1900° F.

A water supply conduit 342 is fixedly secured in a coiled array upon the external peripheral surface portion of the outer cylindrical housing or tube 302, with the water inlet end 344 being illustrated at the upper left end portion of FIGS. 8 and 9 while the water outlet end 346 of the water supply conduit 340 is fluidically connected to a water infeed pipe or conduit 348, as best seen in FIG. 8, which feeds or conducts water into the annular space 338 defined between the external peripheral wall portion of the inner cylindrical housing or tube 336 and the internal peripheral wall portion of the outer cylindrical housing or tube 302. In this manner, when the infrared non-immersion heaters 304 are energized, they serve to heat the cylindrical wall portion forming the inner cylindrical housing or tube 336, which thereby, in turn, causes the plurality of radially oriented heat exchanger fins 340 to be heated so as to heat the water disposed within the annular chamber or space 338 defined between the external peripheral wall portion of the inner cylindrical housing or tube 336 and the internal peripheral wall portion of the outer cylindrical housing or tube 302, thereby causing the water to effectively be converted to steam. A steam outlet conduit 350 is fluidically connected to an upper semi-cylindrical portion of the mini steam generator 300 and is fluidically connected to the annular space 338 such that steam from the annular space 338 can be conducted into the cooking chambers of the steam cooking appliance. Lastly, a suitable drain pipe or conduit 352 is connected to a lower semi-cylindrical portion of the mini steam generator 300 so as to be in fluidic communication with the annular space 338 within which the water is contained so as to facilitate drainage of the same when maintenance or service is required.

The entire mini steam generator 300 of this embodiment, including the external housing or tube 302, the inner housing or tube 336, the plurality of heat exchanger fins 340, and the coiled water supply conduit 342, is fabricated from copper. The external housing 302 has a diametrical extent of approximately six inches (6.0″) and an axial length of approximately fourteen inches (14.0″). It is also to be noted that the heated water and steam, disposed within the annular chamber 338 defined between the external peripheral wall portion of the inner cylindrical housing or tube 336 and the internal peripheral wall portion of the outer cylindrical housing or tube 302, also effectively serves to heat the cylindrical wall portion forming the outer cylindrical housing or tube 302 as well as the coiled water supply conduit 342 fixedly secured to the outer peripheral surface of the cylindrical wall portion forming the outer cylindrical housing or tube 302. In this manner, the water disposed within and flowing through the coiled water supply conduit 342 is preheated from its inflowing temperature of, for example, 50° F., prior to its entry into the annular chamber 338 defined between the external peripheral wall portion of the inner cylindrical housing or tube 336 and the internal peripheral wall portion of the outer cylindrical housing or tube 302, and in preparation of the water being ultimately heated to 212° F. so as to be converted into steam for fluidic communication to the food cooking chambers.

Obviously, many variations and modifications of the present invention are possible in light of the above teachings. It is therefore to be understood that within the scope of the appended claims, the present invention may be practiced otherwise than as specifically described herein.

### KEY TO REFERENCE NUMBERS IN THE DRAWINGS

100—First embodiment of mini steam generator
102—Cylindrical housing or tube of mini steam generator 100
104—Immersion heaters of mini steam generator 100
106—Left end wall of mini steam generator 100
108—Right end wall of mini steam generator 100
110—Inlet water supply tube of mini steam generator 100
111—Electrical connectors of immersion heaters 104
112—Water inlet pump operatively associated with inlet water supply tube
114—Baffle member
116—Probe for detecting the water level within the mini steam generator
118—Steam outlet valves
120—Pressure relief valve of cylindrical housing or tube 102
122—Thermostatically controlled drain valve of cylindrical housing/tube 102
124—Rear chamber of 126 for accommodating mini steam generator
125—Housing of modular cooking appliance 126
126—First embodiment modular cooking appliance
128—Food cooking chambers of appliance 126
130—Drawers of appliance 126
132—Food-holding trays of modular cooking appliance 126
134—Food preparation station
224—Right chamber of appliance 226 housing the mini steam generator
225—Housing of modular cooking appliance 226
226—Second embodiment modular cooking appliance
228—Food cooking chamber of modular cooking appliance 226
230—Drawer of modular cooking appliance 226
232—Food-holding tray mounted within drawer 230
234—Food preparation station
236—Expanded food preparation station
300—Third embodiment mini steam generator
302—Outer housing or tube of 300
304—Infrared heaters or heating elements within 336
336—Inner housing or tube of 300
338—Annular space between 302 and 336
340—Heat exchanger fins upon external peripheral surface of 336
342—Water supply tube coiled around external surface of 302
344—Inlet end of water supply tube 342
346—Outlet end of water supply tube 342
348—Water infeed pipe or conduit connecting 342 to 338
350—Steam outlet conduit of 300 leading to food cooking chambers
352—Water drain pipe of mini steam generator 300

What is claimed as new and desired to be protected by Letters Patent of the United States of America, is:

1. A mini steam generator for use in connection with an appliance for the preparation of food by a steaming process, comprising:
a housing;
an inlet water supply tube for supplying water into said housing;
at least one immersion heater disposed within said housing, submerged within said water disposed within said housing, and adapted to heat said water so as to convert said water to steam; and
at least one steam outlet valve and conduit for permitting said steam to be routed from said housing to the appliance so as to prepare the food by a steaming process.

2. The mini steam generator as set forth in claim 1, wherein:
said at least one steam outlet valve is a thermostatically controlled steam outlet valve which will be closed when the temperature within said housing reaches a predetermined temperature level.

3. The mini steam generator as set forth in claim 1, wherein:
said housing comprises an elongated cylinder.

4. The mini steam generator as set forth in claim 1, wherein:
said housing is fabricated from stainless steel.

5. The mini steam generator as set forth in claim 1, wherein:
said at least one immersion heater disposed within said housing and submerged within said water comprises four (4) immersion heaters.

6. The mini steam generator as set forth in claim 5, wherein:
said four (4) immersion heaters comprises two pair of immersion heaters disposed opposite each other.

7. The mini steam generator as set forth in claim 6, wherein:
a first pair of said two pair of immersion heaters project axially inwardly through a first end portion of said housing, and a second pair of said two pair of immersion heaters project axially inwardly through a second end portion of said housing which is disposed opposite said first end portion of said housing.

8. The mini steam generator as set forth in claim 1, further comprising:
a probe extending substantially radially inwardly through a side wall portion of said housing for detecting the level of said water disposed within said housing and thereby terminate further inflow of water into said housing.

9. The mini steam generator as set forth in claim 1, wherein:
said mini steam generator is disposed within a modular cooking appliance.

10. The mini steam generator as set forth in claim 9, wherein:
the modular cooking appliance is fixedly connected to at least one other modular cooking appliance whereby the pair of modular cooking appliances comprise a food preparation station.

11. The mini steam generator as set forth in claim 10, wherein:
the pair of modular cooking appliances forming the food preparation station can be disposed in a side-by-side arrangement with respect to each other.

12. The mini steam generator as set forth in claim 10, wherein:
the pair of modular cooking appliances forming the food preparation station can be disposed in a vertically stacked arrangement with respect to each other.

13. The mini steam generator as set forth in claim 1, wherein:
said housing of said mini steam generator has a diametrical extent between two and six inches (2.00-6.00″) and a length between ten and twenty inches (10.00-20.00″).

14. A mini steam generator for use in connection with an appliance for the preparation of food by a steaming process, comprising:
a first outer housing having a first predetermined diametrical extent;
a second inner housing having a second predetermined diametrical extent which is less than said first predetermined diametrical extent of said first outer housing such that an annular space is defined between an external peripheral wall surface of said second inner housing and an internal peripheral wall surface of said first outer housing;
at least one non-immersion heater disposed within said second inner housing for heating said peripheral wall of said second inner housing;
an inlet water supply tube for supplying water into said annular space defined between said first outer and second inner housings whereby said water disposed within said annular space will be heated by said peripheral wall of said second inner housing and converted into steam; and
a steam outlet conduit operatively connected to said annular space for permitting said steam to be routed from said annular space of said second inner housing to the appliance so as to prepare the food by a steaming process.

15. The mini steam generator as set forth in claim 14, wherein:
said first outer and second inner housings comprise elongated cylinders.

16. The mini steam generator as set forth in claim 14, wherein:
said at least one non-immersion heater disposed within said second inner housing comprises a plurality of non-immersion heaters disposed within a circumferential array around a central longitudinal axis of said second inner housing.

17. The mini steam generator as set forth in claim 14, wherein:
said inlet water supply tube is fluidically connected to a lower portion of said annular space defined between said first outer and second inner housings; and
said steam outlet conduit is fluidically connected to an upper portion of said annular space defined between said first outer and second inner housings.

18. The mini steam generator as set forth in claim 14, further comprising:
a plurality of axially spaced, radially oriented, and circumferentially extending heat exchanger fins disposed upon said external peripheral wall surface portion of said second inner housing for imparting heat to said water disposed within said annular space defined between said external peripheral wall surface of said second inner housing and said internal peripheral wall surface of said first outer housing.

19. The mini steam generator as set forth in claim 14, wherein:
said inlet water supply tube comprises a conduit fixedly secured to and coiled around an external surface portion of said first outer housing such that as said water, disposed within said annular space defined between said external peripheral wall surface of said second inner housing and said internal peripheral wall surface of said first outer housing is heated, heat from said heated water is utilized to preheat water being conducted through said inlet water supply tube.

20. The mini steam generator as set forth in claim 19, wherein:
said first outer housing, said second inner housing, said heat exchanger fins disposed upon said external wall portion of said inner housing, and said water inlet supply tube, are all fabricated from copper.

21. The mini steam generator as set forth in claim 14, wherein:
said mini steam generator is disposed within a modular cooking appliance.

22. The mini steam generator as set forth in claim 14, wherein:
the modular cooking appliance is fixedly connected to at least one other modular cooking appliance whereby the pair of modular cooking appliances comprise a food preparation station.

23. The mini steam generator as set forth in claim 22, wherein:
the pair of modular cooking appliances forming the food preparation station can be disposed in a side-by-side arrangement with respect to each other.

24. The mini steam generator as set forth in claim 22, wherein:
the pair of modular cooking appliances forming the food preparation station can be disposed in a vertically stacked arrangement with respect to each other.

25. The mini steam generator as set forth in claim 14, wherein:
said housing of said mini steam generator has a diametrical extent between two and six inches (2.00-6.00″) and a length between ten and twenty inches (10.00-20.00″).
